(19) United States
(12) Patent Application Publication
(10) Pub. No.: US 2022/0206991 A1
(43) Pub. Date: Jun. 30, 2022

(54) STORAGE SYSTEM AND DATA MANAGEMENT METHOD

(71) Applicant: Hitachi, Ltd., Tokyo (JP)

(72) Inventors: Mitsuo HAYASAKA, Tokyo (JP); Shimpei NOMURA, Tokyo (JP); Yuto KAMO, Tokyo (JP); Hideki NAGASAKI, Tokyo (JP); Kenta SHIGA, Tokyo (JP)

(21) Appl. No.: 17/209,368

(22) Filed: Mar. 23, 2021

(30) Foreign Application Priority Data
Dec. 24, 2020 (JP) 2020-214534

(51) Int. Cl. G06F 16/14; G06F 16/16; G06F 16/182; G06F 16/13

(52) U.S. Cl. CPC G06F 16/148; G06F 16/164; G06F 16/13; G06F 16/1824; G06F 16/156

(57) ABSTRACT

A storage system is capable of sharing files between a plurality of sites each having a storage which provides a file system without having to mutually hold the associated files of all files between such sites. The storage has a storage apparatus storing data of a file and a controller connected to the storage apparatus; the storage system includes an associated file which is associated with the file and refers to the file; when the file is to be updated, the controller updates the file and the associated file based on a reference status from the associated file; and when an access request for accessing a file stored in another site is received, the controller makes an inquiry to the other site, and creates an associated file for accessing the file corresponding to the access request in a site of a controller that received the access request.

### CROSS-REFERENCE TO RELATED APPLICATION

The present application claims priority from Japanese application JP2020-214534, filed on Dec. 24, 2020, the contents of which is hereby incorporated by reference into this application.

### TECHNICAL FIELD

The present invention generally relates to a storage system and a data management method for sharing files between distributed sites.

### BACKGROUND ART

The data volume of digital data is increasing rapidly, and corporations are analyzing such data to promote the utilization and application of data for extracting business knowledge. Non-structured data which accounts for a large percentage among the increasing digital data is generally collected in a file storage or an object storage and then analyzed.

Moreover, system configurations such as a hybrid cloud and a multi cloud, which are configured by combining on-premises, private cloud, public cloud and the like, are becoming popular. In order for corporations to utilize and apply data in a system across a plurality of sites, such system requires a function for finding necessary data from each of the distributed sites, and transferring data to be analyzed to its own site.

The foregoing system creates stub information holding metadata in a user file stored in a file object storage installed in a certain site, and in a file object storage of another site. Moreover, the system provides a recall function of acquiring data from the other site at the time of referring to the stub information. In addition, the foregoing system provides a stubbing function of setting aside metadata and deleting data from a file object storage installed in the site and a function of replicating a user file in the file object storage of the other site regarding user files that are not accessed frequently. These functions provided in coordination by the file object storages installed in these sites are referred to as the file virtualization function.

In recent years, a method of confirming the existence of a file by sharing, between sites, the stub information of the respective sites, detecting the reference of the stub information, and acquiring necessary data blocks has been disclosed (refer to PTL 1). Moreover, a global lock is acquired for maintaining the consistency between the sites regarding the update of metadata.

### CITATION LIST

### Patent Literature

[PTL 1] International Publication No. 2016/121093

### SUMMARY OF THE INVENTION

### Problems to be Solved by the Invention

Nevertheless, with the technology described in PTL 1, consumption of the storage capacity of the storage will increase since the stub information of the user file (for example, associated file which refers to the user file) stored between the sites is mutually held in such sites. In addition, when a site is added, it is necessary to acquire data from the other sites for creating an associated file in the new site, and this process requires time.

The present invention was devised in view of the foregoing points, and an object of this invention is to propose a storage system and a data management method capable of sharing files between sites without having to mutually hold the associated files of all files between such sites.

### Means to Solve the Problems

In order to achieve the foregoing object, the present invention provides a storage system capable of sharing files between a plurality of sites each comprising a storage which provides a file system, wherein: the storage comprises a storage apparatus storing data of a file and a controller connected to the storage apparatus; the storage system includes an associated file which is associated with the file and refers to the file; when the file is to be updated, the controller updates the file and the associated file based on a reference status from the associated file; and when an access request for accessing a file stored in another site is received, the controller makes an inquiry to the other site, and creates an associated file for accessing the file corresponding to the access request in a site of a controller that received the access request.

With the configuration described above, since an associated file is created according to the access request for accessing the file stored in another site, the storage does not need to store the associated files of all files in the other sites, and the number of associated files required for sharing files between sites can be reduced. For example, the storage capacity required for storing the associated files in the respective sites, and the time required for acquiring the associated files upon adding a new site, can be improved.

### Advantageous Effects of the Invention

According to the present invention, files can be shared between sites without having to mutually hold the associated files of all files between such sites.

### BRIEF DESCRIPTION OF DRAWINGS

FIG. 1 is a diagram showing an example of the configuration of the storage system according to the first embodiment.

FIG. 2 is a diagram showing an example of the configuration of the file object storage.

FIG. 3 is a diagram showing an example of the user file and the user directory according to the first embodiment.

FIG. 4 is a diagram showing an example of the metadata DB according to the first embodiment.

FIG. 5 is a diagram showing an example of the management information file according to the first embodiment.

FIG. 6 is a diagram showing an example of the operation log according to the first embodiment.

FIG. 7 is a diagram showing an example of the access right management table according to the first embodiment.

FIG. 8 is a diagram showing an example of the site-to-site connection management table according to the first embodiment.

FIG. 9 is a diagram showing an example of the site-to-site transverse metadata search result reply according to the first embodiment.
FIG. 10 is a diagram showing an example of the site-to-site transverse metadata search processing according to the first embodiment.

FIG. 11 is a diagram showing an example of the in-site metadata search processing according to the first embodiment.

FIG. 12 is a diagram showing an example of the stub creation processing according to the first embodiment.

FIG. 13 is a diagram showing an example of the background data acquisition processing according to the first embodiment.

FIG. 14 is a diagram showing an example of the file reference processing according to the first embodiment.

FIG. 15 is a diagram showing an example of the data acquisition site selection processing according to the first embodiment.

FIG. 16 is a diagram showing an example of the file update processing according to the first embodiment.

FIG. 17 is a diagram showing an example of the operation log analysis processing according to the first embodiment.

FIG. 18 is a diagram showing an example of the metadata extraction processing according to the first embodiment.

FIG. 19 is a diagram showing an example of the replication processing according to the first embodiment.

FIG. 20 is a diagram showing an example of the stubbing processing according to the first embodiment.

### DESCRIPTION OF EMBODIMENTS

### (I) First Embodiment

An embodiment of the present invention is now explained in detail. The present invention, however, is not limited to the following embodiment.

A file object storage which follows one perspective of the present invention comprises a metadata database (metadata DB) for managing the metadata of user files. Moreover, the file object storage receives a search query from a client terminal, transfers the search query to all sites, and searches for the corresponding user file from the metadata DB of the respective sites. In addition, the file object storage creates stub information in the file object storage within the site regarding the user file selected from the search result.

An embodiment of the present invention is now explained with reference to the appended drawings. The following descriptions and drawings are illustrations for explaining the present invention, and certain descriptions and drawings are omitted or simplified as needed for clarifying the explanation of the present invention. The present invention can also be worked in various other modes. Unless specifically limited, each constituent element may be singular or plural.

Note that, in the following explanation, the same number is assigned to the same element in the drawings, and the explanation thereof is omitted as needed. Moreover, when the same types of elements are explained without being differentiated, the common part (part excluding the branch number) of the reference code including the branch number will be used, and when the same types of elements are explained by being differentiated, the reference code including the branch number may be used. For example, when the sites are explained without any particular differentiation, they will be indicated as “sites 110”, and when the individual sites are explained by being differentiated, they may be indicated as “site 110-1”, “site 110-2” and so on.

Expressions such as “first”, “second” and “third” used in the present specification are assigned for identifying the constituent elements, and do not necessarily limit the quantity or order of such constituent elements. Moreover, numbers for identifying the constituent elements are used for each context, and a number used in one context may not necessarily show the same configuration in another context. Moreover, a constituent element identified with a certain number is not precluded from concurrently serving the function of a constituent element identified with a different number.

### <System Configuration>

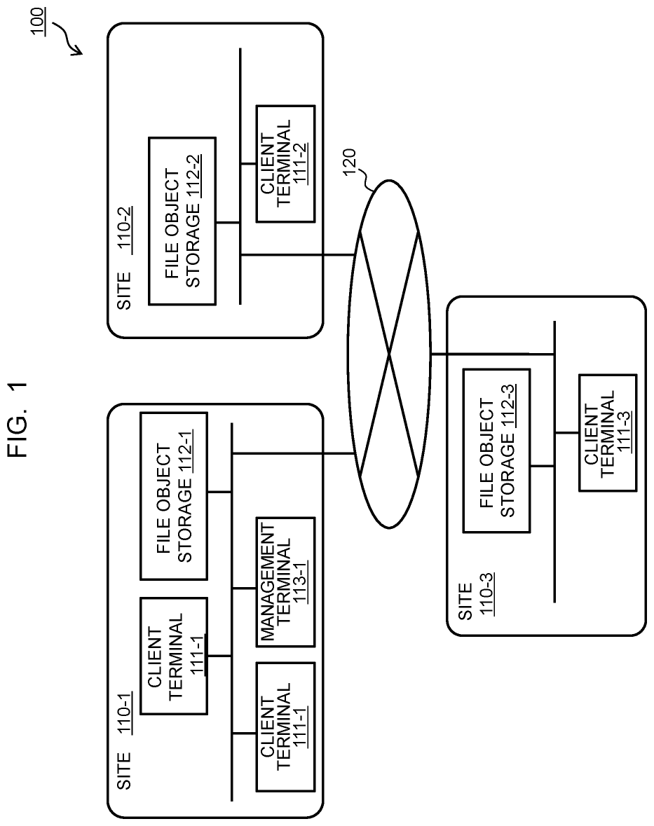

FIG. 1 is a diagram showing an example of the configuration of the storage system 100 according to this embodiment.

The storage system 100 comprises sites 110-1, 110-2, and 110-3. The sites 110 are connected with a network 120, which is a WAN (Wide Area Network). Note that, while FIG. 1 shows three sites 110-1, 110-2, and 110-3, there is no particular limitation in the number of sites 110 in this embodiment.

The site 110-1 comprises a client terminal 111-1, a file object storage 112-1, and a management terminal 113-1. The client terminal 111-1 and the file object storage 112-1 and the management terminal 113-1 are mutually connected, for example, with a network such as a LAN (Local Area Network) within the site 110-1.

The client terminal 111 is an information processing device such as a computer capable of performing various types of information processing. The client terminal 111 stores user files in the file object storage 112, and performs various types of operations such as reading user files and writing in user files. The specific configuration of the file object storage 112 will be described later. The management terminal 113 is an information processing device such as a computer capable of performing various types of information processing. The management terminal 113 manages the file object storage 112, and, when there is any abnormality in the file object storage 112, instructs the file object storage 112 to perform various types of operations.

The site 110-2 and the site 110-3 also comprise a client terminal 111 and a file object storage 112. Note that the hardware configuration of the sites 110-1, 110-2, and 110-3 illustrated in FIG. 1 is merely an exemplification, and there is no limitation in the quantity or inclusion of other hardware configurations so as long as it is a configuration in which each site comprises at least one file object storage 112.

### <File Object Storage>

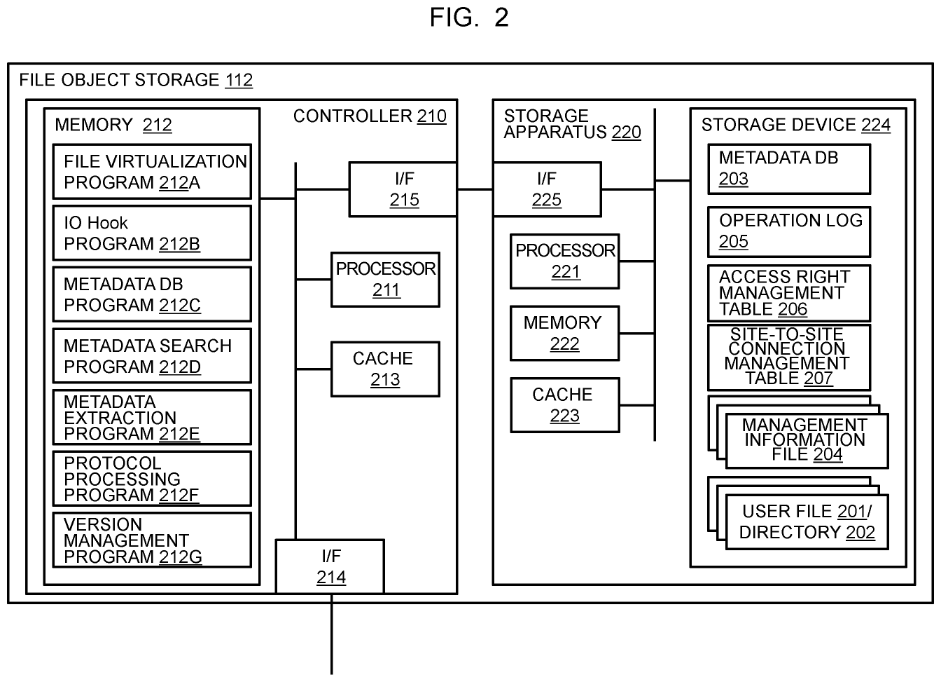

FIG. 2 is a diagram showing an example of the configuration of the file object storage 112.

The file object storage 112 comprises a controller 210 and a storage apparatus 220.

The controller 210 comprises a processor 211, a memory 212, a cache 213, an interface 214 (I/F), and an interface 215 (I/F).

The processor 211 controls the overall operation of the controller 210 and the file object storage 112. The memory 212 temporarily stores the programs and data used in the operational control of the processor 211. The cache 213 temporarily stores the data to be written from the client terminal 111 and the data read from the storage apparatus 220. The interface 214 communicates with the other client terminals 111 and file object storages 112 in the sites 110-1, 110-2, and 110-3. The interface 215 communicates with the storage apparatus 220.

The memory 212 stores a file virtualization program 212A, an 10 Hook program 212B, a metadata DB program 212C, a metadata search program 212D, a metadata extraction program 212E, a protocol processing program 212F, and a version management program 212G.

The storage apparatus 220 comprises a processor 221, a memory 222, a cache 223, a storage device 224, and an interface 225 (I/F).

The processor 221 performs the operational control of the storage apparatus 220. The memory 222 temporarily stores the programs and data used in the operational control of the processor 221. The cache 223 temporarily stores the data to be written from the controller 210 and the data read from the storage device 224. The storage device 224 stores various files. The interface 225 communicates with the controller 210. The storage device 224 stores a user file 201, a user directory 202, a metadata DB 203, a management information file 204, an operation log 205, an access right management table 206, and a site-to-site connection management table 207.

The file virtualization program 212A monitors the operation log 205, and performs processing (replication processing or stubbing processing or recall processing) to the user file 201 and the user directory 202 according to a request from the client terminal 111.

The IO Hook program 212B monitors the processing performed to the user file 201 and the user directory 202 issued by the protocol processing program 212F in response to a request from the client terminal 111, and, when processing occurs, updates the management information by adding the operation contents to the operation log 205, and updating the metadata DB 203 and the management information file 204 associated with the operation.

The metadata DB program 212C manages the metadata DB 203.

The metadata search program 212D coordinates with the metadata search program 212D of all sites 110, makes a request to the metadata DB program 212C of each site 110, and collects and processes the metadata of the user file 201 included in the metadata DB 203 based on a search query from the client terminal 111.

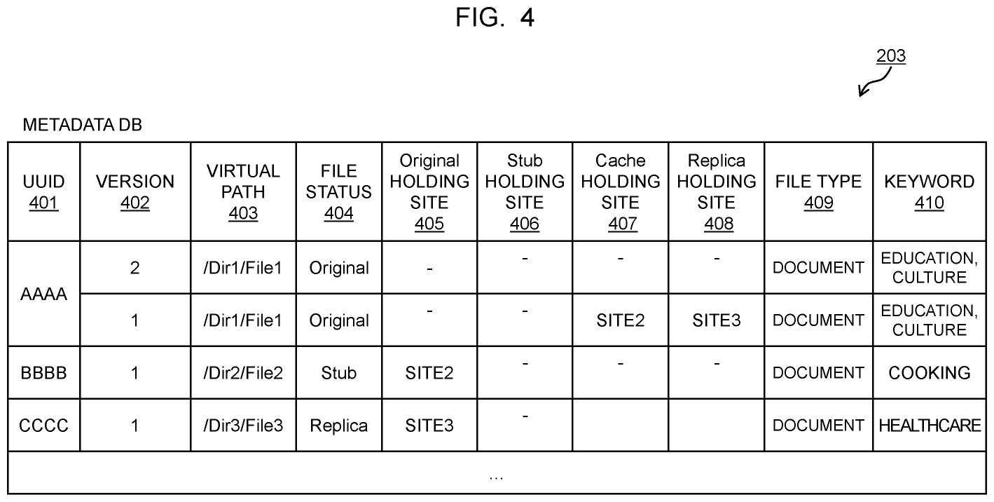

The metadata extraction program 212E analyzes the data of the user file 201 and extracts the metadata, and registers the extracted metadata in the metadata DB 203 based on a request from the file virtualization program 212A. Moreover, the metadata extraction program 212E analyzes the data of the user file 201 and extracts the metadata, and registers the extracted metadata in the metadata DB 203 based on a request from the client terminal 111. In this embodiment, while FIG. 4 described later is illustrated as an example of the metadata registered in the metadata DB 203, for example, there is no limitation regarding the type and quantity of metadata to be registered, and the name of the object recognized in the photo file or the information of the estimated photo location may also be registered.

The protocol processing program 212F receives various requests from the client terminal 111, and processes the protocol included in the requests.

The version management program 212G is a program which, when the data stored in the file object storage 112 is updated, sets aside the data before being updated, creates a different version of that data, and manages that data.

### <File Storage Configuration>

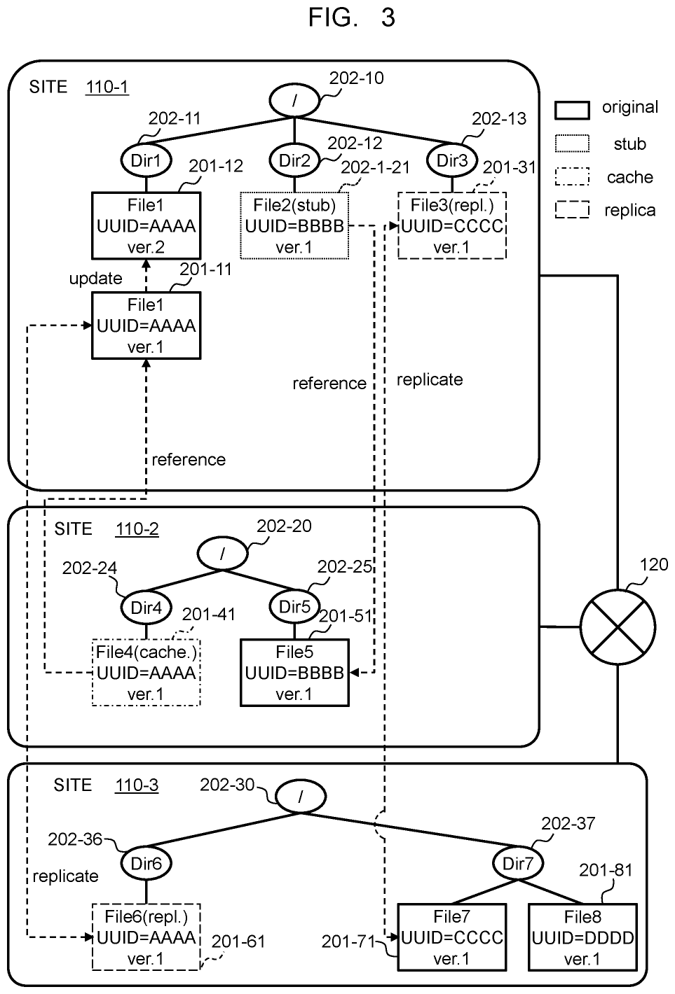

FIG. 3 is a diagram showing an example of the user file 201 and the user directory 202 stored in the file object storage 112.

FIG. 3 shows that, in each site 110, the client terminal 111 is storing data in a file system provided by the file object storage 112. As an example, the site 110-1 comprises user directories 202-11, 202-12, and 202-13 under a user directory 202-10 (route directory). The user directories 202-11, 202-12, and 202-13 each comprise user files 201-12, 201-21, and 201-31.

Note that, while FIG. 3 shows an example where the client terminal 111 operates the user file 201 on the file system provided by the file object storage 112, the operation of the user file 201 is not limited to this example. For instance, the configuration may also be such that the user file 201 is designated based on the URI (Uniform Resource Identifier) as the object storage and the operation is performed based on S3 (Simple Storage Service), Swift protocol.

### <Version Management Function>

Moreover, the file object storage 112 includes a version management function, and can designate user files 201 of different versions and perform operations. As an example, the site 110-1 comprises a user file 201-11 as an old version of the user file 201-12. As a general rule, while the file object storage 112 applies the respective operations from the client terminal 111 to the latest user file 201, operations of the user file 201 of the old version can also be performed by designating the version at the time of performing the operations. Note that, while the file object storage 112 provides the version management function in this embodiment, for example, the old user file 201 may also be set aside, for instance, according to a method of creating a replication of the user file 201.

### <UUID (Universally Unique Identifier)>

A UUID is assigned to each user file 201. A user file 201 of a different site 110 and a user file 201 of a different file path are allowed to have the same values for both the UUID and the version, and the user files 201 having the same UUID and version refer to the same data. For example, since the user file 201-11 and the user file 201-41 and the user file 201-61 have the same UUID and version, the same data is returned in response to a reference operation from the client terminal 111. Even with the user files 201 to which a different file path has been assigned between the sites 110, since there are cases in which the data indicated by the UUID and the version are the same, with the storage system 100, the file path is treated as the virtual path (virtual path), and the UUID and the version are treated as the path (real path) for identifying the actual data.

### <File Status>

The user files 201 having the same UUID and version are classified into the four file statues of an Original status, a Stub status, a Cache status, and a Replica status.

The Original status is the first file status of the user file 201 created by the client terminal 111. The user file 201 of an Original status comprises all data of the user file 201. The Stub status is the file status that may include a part of the data of the user file 201 of an Original status. The user file 201 of a Stub status is created for referring to the user file 201 of an Original status of the other sites 110, and does not include all or a part of the data of the user file 201. With regard to the user file 201 of a Stub status, when a reference operation of non-held data is received from the client terminal 111, data is acquired from the user file 201 of an Original status or a Replica status having the same UUID and version. The Cache status is the file status that results when the user file 201 of a Stub status completes the acquisition of all data. The Replica status is the file status in which all data included in the user file 201 are held as the redundant data of the user file 201 of an Original status.

The Original status is the file status that can only be held by a single user file 201 among the user files 201 having the same UUID and version, and allows the write operation by the client terminal 111. It is thereby possible to avoid a lock acquisition of all user files 201 of the same UUID and version each time a write operation is performed. When a write operation by the client terminal 111 is performed to the user file 201 of a Stub status, a Cache status, or a Replica status, the data is updated after a different UUID is assigned. The Cache status and the Replica status are both the file status comprising all data. However, the data of the user file 201 of a Replica status differs with respect to the point that its destruction is not allowed for data protection. Thus, during a write operation to the user file 201 of a Replica status, the update is reflected after the data is replicated and a new UUID is assigned. Meanwhile, during a write operation to the user file 201 of a Cache status, the update is reflected after a new UUID is assigned without replicating the data.

Note that, in this embodiment, during a write operation to the user file 201 of a Stub status, a Cache status, or a Replica status, a different UUID is assigned and the update is reflected. However, for example, the configuration may also be such that a write operation to the user file 201 of a Stub status, a Cache status, or a Replica status is prohibited, or all user files 201 having the same UUID in the storage system 100 are reflected in the update during the write operation.

### <Metadata DB>

FIG. 4 is a diagram showing an example of the metadata DB 203 of the file object storage 112.

The entries of the metadata DB 203 may be created for each user file 201 in the file object storage 112.

The entries of the metadata DB 203 include the information of a UUID 401, a version 402, a virtual path 403, a file status 404, an Original holding site 405, a Stub holding site 406, a Cache holding site 407, a Replica holding site 408, a file type 409, and a keyword 410.

The UUID 401 stores information indicating the UUID assigned to the user file 201. The version 402 stores information indicating the version of the user file 201. The virtual path 403 stores information indicating the virtual path of the user file 201. The file status 404 stores information indicating the file status of the user file 201.

The Original holding site 405 stores information indicating the other sites 110 storing the user file 201 in which the UUID 401 and the version 402 are of the same values and in which the file status is the Original status. The Stub holding site 406 stores information indicating the other sites 110 storing the user file 201 in which the UUID 401 and the version 402 are of the same values and in which the file status is the Stub status. The Cache holding site 407 stores information indicating the other sites 110 storing the user file 201 in which the UUID 401 and the version 402 are of the same values and in which the file status is the Cache status. The Replica holding site 408 stores information indicating the other sites 110 storing the user file 201 in which the UUID 401 and the version 402 are of the same values and in which the file status is the Replica status.

The file type 409 stores information indicating the file type of the user file 201. The keyword 410 stores information indicating the keyword extracted by the metadata extraction program 212E from the contents of the data of the user file 201.

While the keyword 410 was illustrated as an example of the information extracted by the metadata extraction program 212E and registered in the metadata DB 203, for example, the keyword 410 may also store numerous types of information different from the foregoing example, such as information of the name of the object recognized in the photo file or the estimated photo location.

### <Management Information File>

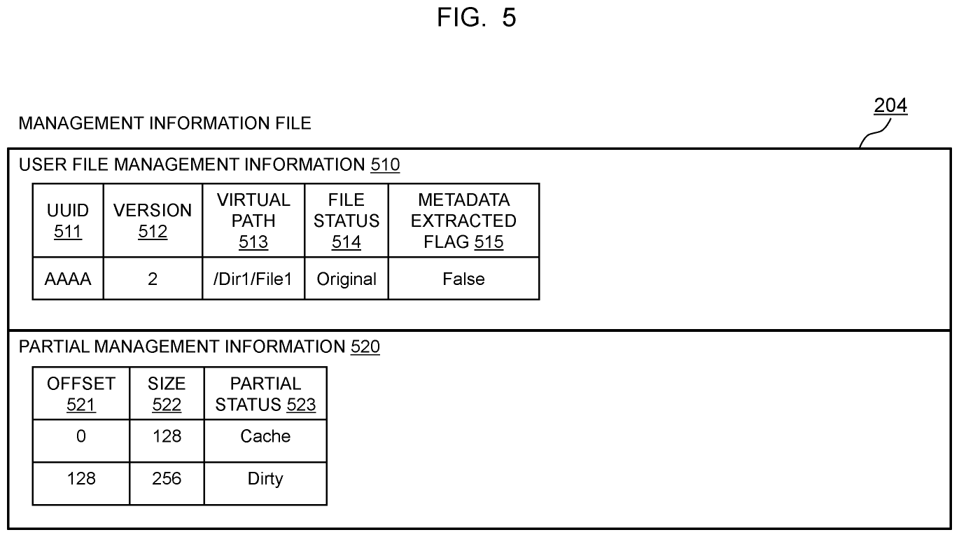

FIG. 5 is a diagram showing an example of the management information file 204 of the file object storage 112.

The management information file 204 is created for each user file 201 in the file object storage 112. The management information file 204 comprises user file management information 510 and partial management information 520.

The user file management information 510 includes information of a UUID 511, a version 512, a virtual path 513, a file status 514, and a metadata extracted flag 515.

The UUID 511 stores information indicating the UUID assigned to the user file 201. The version 512 stores information indicating the version of the user file 201. The virtual path 513 stores information indicating the virtual path of the user file 201. The file status 514 stores information indicating the file status of the user file 201. The metadata extracted flag 515 stores information indicating whether the metadata extraction processing S1800 described later has been applied with regard to the user file 201.

The partial management information 520 is configured from a plurality of entries corresponding to an area of the user file 201 represented with an offset 521 and a size 522. Each entry of the partial management information 520 includes information of an offset 521, a size 522, and a partial status 523.

The offset 521 stores information indicating an offset of the area in the user file 201 indicated by the entry. The size 522 stores information indicating the size of the area in the user file 201 indicated by the entry. The partial status 523 stores information indicating the partial status of the area of the user file 201 indicated by the entry.

The partial status 523 may take on any one of the three values among “Cache”, “Stub” and “Dirty”. “Cache” indicates that the data of the target area is held in the user file 201 of its own site 110, and that the data of the target area has been reflected in the user file 201 of the other sites 110 in which the UUID 511 and the version 512 are of the same values and in which the file status is the Replica status. “Stub” indicates that the data of the target area is not held in the user file 201 of its own site 110, and that the data of the target area needs to be recalled from the other sites 110 during a read operation from the client terminal 111, and “Dirty” indicates that the data of the target area is held in the user file 201 of its own site 110, and that the data of the target area has not been reflected in the user file 201 of the other sites 110 in which the UUID 511 and the version 512 are of the same values and in which the file status is the Replica status.

### <Operation Log>

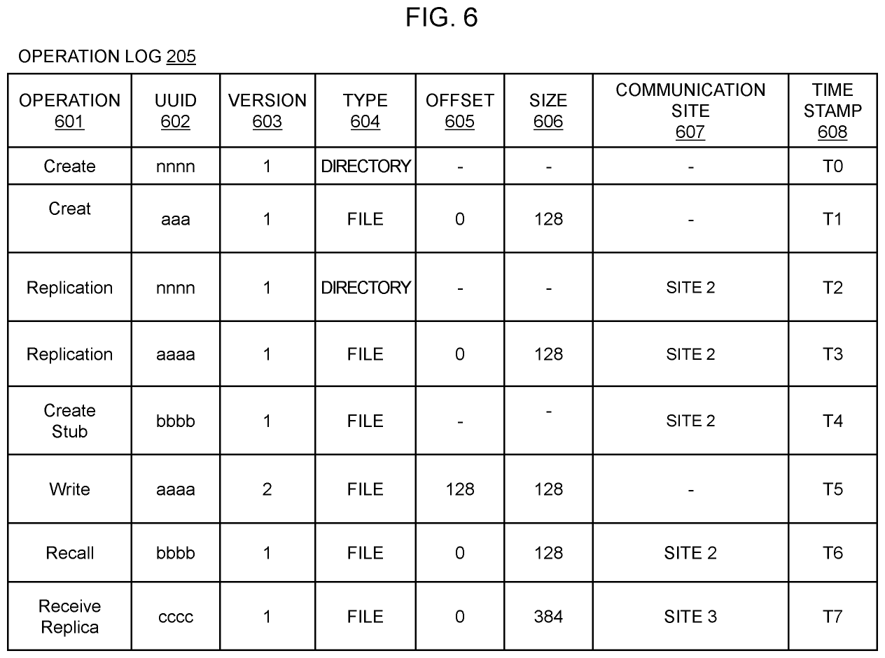

FIG. 6 is a diagram showing an example of the operation log 205 of the file object storage 112.

The entries of the operation log 205 are created for each operation that occurs in the file object storage 112.

The entries of the operation log 205 include information of an operation 601, a UUID 602, a version 603, a type 604, an offset 605, a size 606, a communication site 607, and a time stamp 608.

The operation 601 stores information indicating the type of operation that occurred. The UUID 602 stores information indicating the UUID assigned to the operation target user file 201 or the user directory 202. The version 603 stores information indicating the version of the operation target user file 201 or the user directory 202. The type 604 stores information indicating the type of the operation target. The offset 605 stores information indicating the offset of the area of the operation target. The size 606 stores information indicating the size of the area of the operation target. The communication site 607 stores information indicating the site 110 which sent or received the data of the user file 201 or the user directory 202 based on the operation. The time stamp 608 stores information indicating the date and time of the operation.

### <Access Right Management Table>

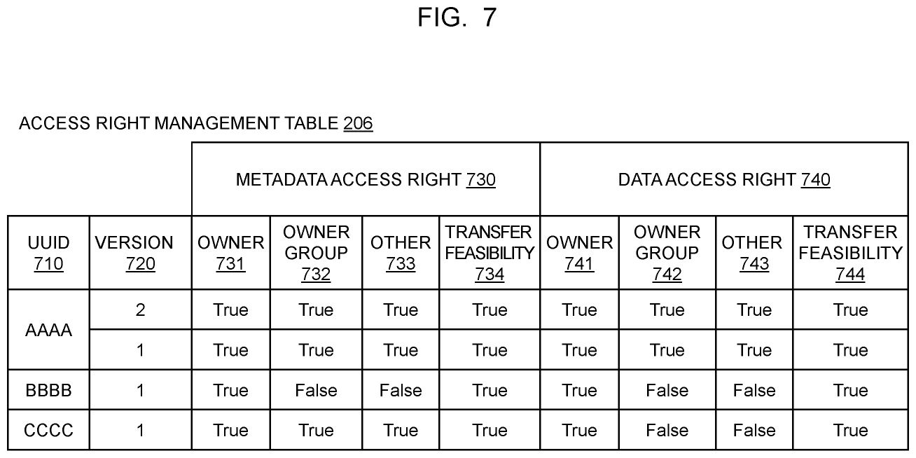

FIG. 7 is a diagram showing an example of the access right management table 206 of the file object storage 112.

The entries of the access right management table 206 are created for each user file 201 in the file object storage 112.

The entries of the access right management table 206 include information of a UUID 710, a version 720, a metadata access right 730, and a data access right 740.

The UUID 710 stores information indicating the UUID assigned to the user file 201. The version 720 stores information indicating the version of the user file 201. The metadata access right 730 stores information indicating the metadata access right of the user file 201. The data access right 740 stores information indicating the data access right of the user file 201.

The metadata access right 730 includes information of an access right 731 (owner), an access right 732 (owner group), an access right 733 (other), and transfer feasibility 734 (feasibility of transferring metadata to another site).

The access right 731 stores information indicating the access right granted to the owner of the user file 201 for accessing the metadata. The access right 732 stores information indicating the access right granted to the owner group of the user file 201 for accessing the metadata. The access right 733 stores information indicating the access right granted to the other users of the user file 201 for accessing the metadata. The transfer feasibility 734 stores information indicating the feasibility of transferring the metadata of the user file 201 to the other sites 110.

The data access right 740 includes information of an access right 741 (owner), an access right 742 (owner group), an access right 743 (other), and transfer feasibility 744 (feasibility of transferring data to another site).

The access right 741 stores information indicating the access right granted to the owner of the user file 201 for accessing the data. The access right 742 stores information indicating the access right granted to the owner group of the user file 201 for accessing the data. The access right 743 stores information indicating the access right granted to the other users of the user file 201 for accessing the data. The transfer feasibility 744 stores information indicating the feasibility of transferring the data of the user file 201 to the other sites 110.

While owner, owner group, other, and transfer feasibility to the other sites 110 were indicated as examples of the types of the metadata access right 730 and the data access right 740, they are not limited to the foregoing examples. For example, the metadata access right 730 and the data access right 740 may include the access right for each affiliated division or affiliated project of the user and the feasibility of transferring data domestically and overseas.

### <Site-to-Site Connection Management Table>

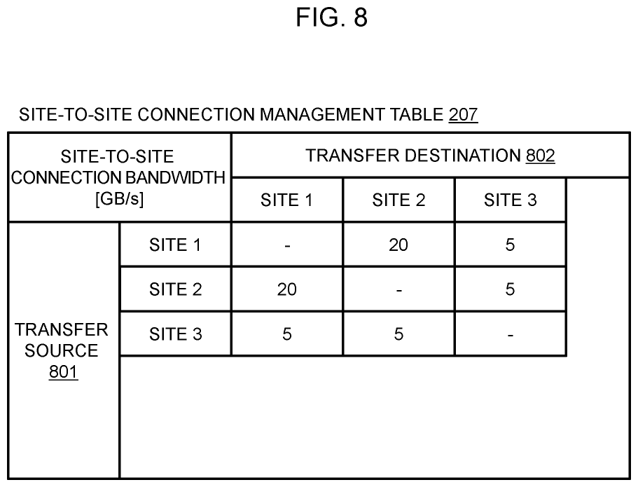

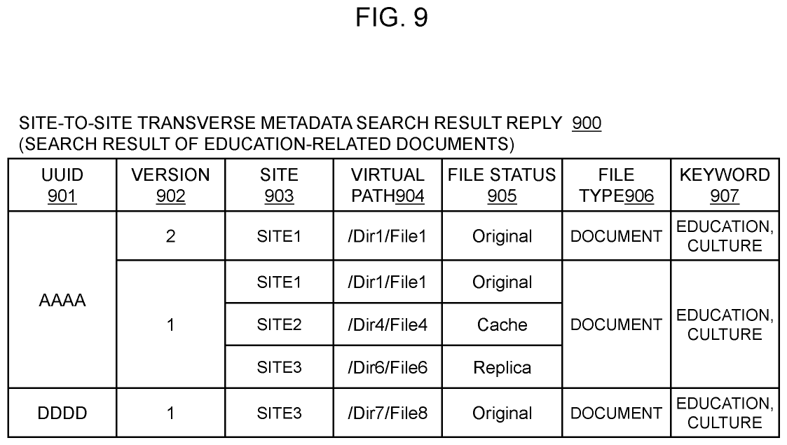

FIG. 8 is a diagram showing an example of the site-to-site connection management table 207 of the file object storage 112.

The site-to-site connection management table 207 stores information of the performance and cost during the communication between the sites 110. In the example of FIG. 8, the site 110 of the transfer source (transfer source 801) is indicated in each line, and the site 110 of the transfer destination (transfer destination 802) is indicated in each column. Each cell indicates the bandwidth upon transferring the data from the transfer source 801 to the transfer destination 802.

While the bandwidth of the data transfer between the respective sites 110 has been indicated as an example of the site-to-site connection management table 207, it is not limited to the foregoing example. For example, the site-to-site connection management table 207 may include multiple pieces of information such as the latency during the data transfer, and billing information upon using the communication path.

### <Site-to-Site Transverse Metadata Search Result Reply>

FIG. 9 is a diagram showing an example of the site-to-site transverse metadata search result reply 900 which is sent as a search result by the metadata search program 212D of the file object storage 112.

The entries of the site-to-site transverse metadata search result reply 900 are created for each user file 201 extracted from all sites 110 as corresponding to the search query.

The entries of the site-to-site transverse metadata search result reply 900 include information of a UUID 901, a version 902, a site 903, a virtual path 904, a file status 905, a file type 906, and a keyword 907.

The UUID 901 stores information indicating the UUID assigned to the user file 201. The version 902 stores information indicating the version of the user file 201. The site 903 stores information indicating the site 110 storing the user file 201. The virtual path 904 stores information indicating the virtual path of the user file 201. The file status 905 stores information indicating the file status of the user file 201. The file type 906 stores information indicating the file type of the user file 201. The keyword 907 stores information indicating the keyword extracted by the metadata extraction program 212E from the contents of the data of the user file 201.

### <Processing Flow>

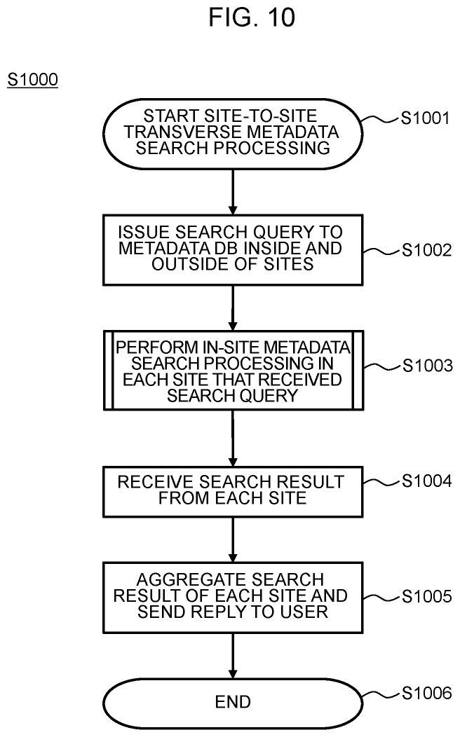

The operation of the storage system 100 of this embodiment is now explained with reference to the flowcharts of FIG. 10 to FIG. 20.

### <Site-to-Site Transverse Metadata Search Processing>

FIG. 10 is a flowchart for explaining an example of the site-to-site transverse metadata search processing S1000 of the storage system 100.

The site-to-site transverse metadata search processing is started by the metadata search program 212D receiving a search query of the site-to-site transverse metadata search from the client terminal 111 (S1001).

Foremost, the metadata search program 212D issues (for example, transfers) a search query to all sites 110, and requests the in-site metadata search processing S1100 described later (S1002).

Next, the metadata search program 212D of each site 110 that received the transferred search query performs the in-site metadata search processing S1100 (S1003).

Next, the metadata search program 212D receives the search result of the in-site metadata search processing S1100 from each site 110 (S1004).

Next, the metadata search program 212D aggregates the search result of each site 110 and returns a reply to the client terminal 111 in the form of the site-to-site transverse metadata search result reply 900 (S1005), and then ends the processing (S1006).

### <In-Site Metadata Search Processing>

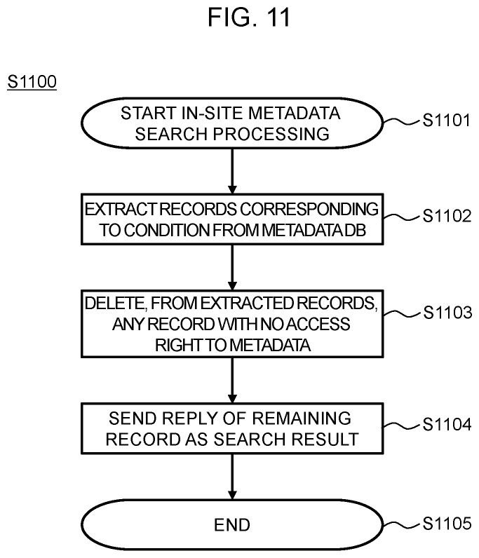

FIG. 11 is a flowchart for explaining an example of the in-site metadata search processing S1100.

The in-site metadata search processing S1100 is started when the search query of the in-site metadata search from the client terminal 111 is received in one of the sites 110 (S1101).

Foremost, the metadata search program 212D makes a request to the metadata DB program 212C and extracts, from the metadata DB 203, a record corresponding to the condition of the search query (S1102).

Next, the metadata search program 212D deletes a record with no access right to the metadata from the records extracted in S1102 (S1103). More specifically, the metadata search program 212D refers to the access right management table 206, and extracts a record in which the site 110 of the transfer source of the search query or the user of the issue source of the search query comprises an access right for accessing the metadata regarding the corresponding user file 201 from such record.

Next, the metadata search program 212D returns the extracted record, as the search result, to the transfer source of the search query (S1104), and then ends the processing (S1105).

### <Stub Creation Processing>

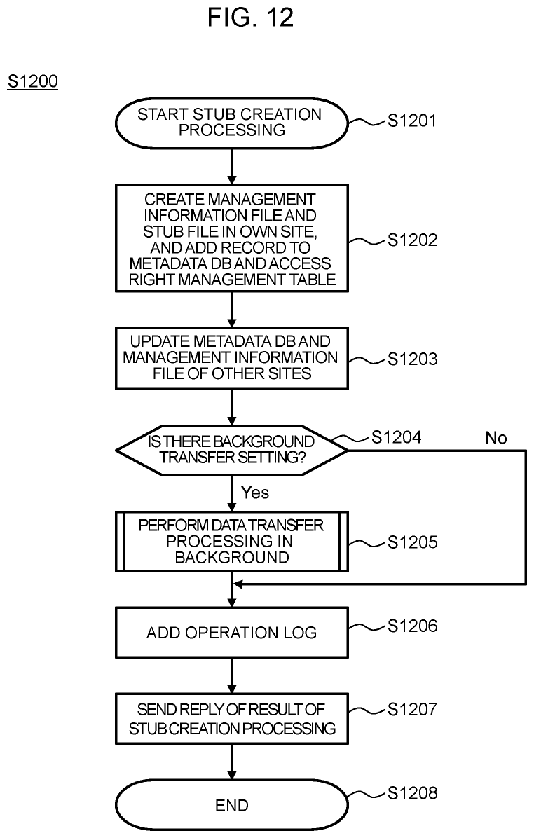

FIG. 12 is a flowchart for explaining an example of the stub creation processing S1200.

The stub creation processing S1200 is started when the file virtualization program 212A receives a stub creation request from the client terminal 111 (S1201). The stub creation request is created, for example, as a result of a record in the site-to-site transverse metadata search result reply 900 being selected by the client terminal 111.

Foremost, the file virtualization program 212A creates, in its own site 110, the management information file 204 and the Stub status user file 201 (stub file) as stub information based on the UUID, the version, and the virtual path designated in the stub creation request, and creates, in the metadata DB 203 and the access right management table 206, a record corresponding to the created user file 201 (S1202).

Next, the file virtualization program 212A notifies the creation of the Stub status user file 201 to the file virtualization program 212A of the other sites 110, and updates the record of the metadata DB 203 and the record of the management information file 204 having the same UUID and version of the other sites 110 (S1203).

Next, the file virtualization program 212A confirms the transfer setting in the background regarding the data of the Stub status user file 201 (S1204). The file virtualization program 212A proceeds to the processing of S1205 when the transfer setting is valid, and proceeds to the processing of S1206 when the transfer setting is invalid. As methods for setting the transfer in the background, adopted may be a method of deciding whether or not to perform a background transfer and the bandwidth to be used in units of a file system, units of a directory, or units of a file, or a method of designating whether or not to perform a background transfer at the time of the stub creation request, or a method of performing a background transfer only during the transfer between the sites 110 of the file system, but there is no particular limitation on such method.

In S1205, the file virtualization program 212A starts the data transfer processing in the background (background data acquisition processing S1300) for acquiring the data of the created Stub status user file 201, and then proceeds to the processing of S1206.

In S1206, the file virtualization program 212A adds the contents of the stub creation operation to the operation log 205.

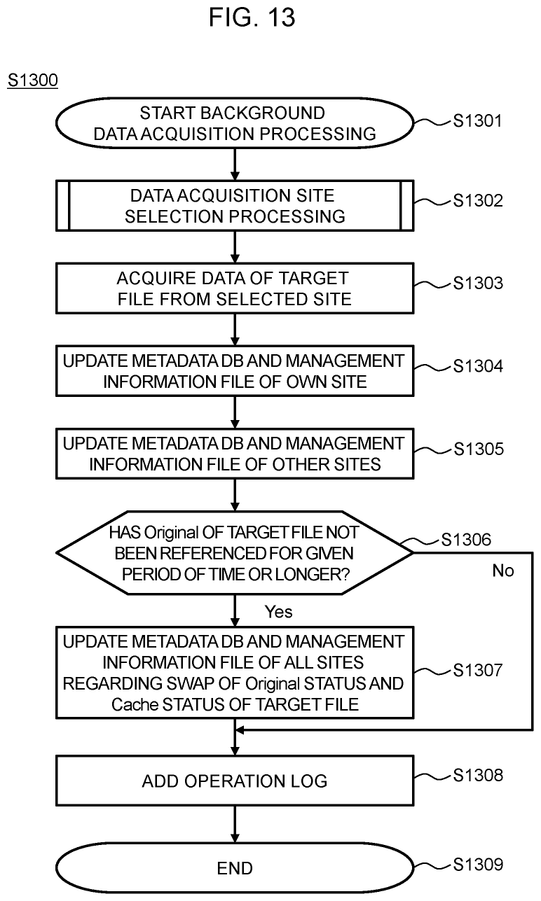

Next, the file virtualization program 212A returns the result of the stub creation processing to the client terminal 111 (S1207), and then ends the processing (S1208).

<Background Data Acquisition Processing>FIG. 13 is a flowchart for explaining an example of the background data acquisition processing S1300.

The background data acquisition processing S1300 is started when a request for performing the data transfer processing in the background during the stub creation processing S1200 is received, or a request for performing the data transfer processing in the background designating a direct specific Stub status user file 201 is received from the client terminal 111 (S1301).

Foremost, the file virtualization program 212A performs the data acquisition site selection processing S1500, and decides the site 110 of the acquisition source of the data of the target user file 201 (S1302).

Next, the file virtualization program 212A designates the UUID and the version of the target user file 201 from the site 110 decided in S1302, acquires the data of the target user file 201 (data of the Stub part), and writes the acquired data in the target user file 201 (S1303).

Next, the file virtualization program 212A reflects, in the record of the metadata DB 203 and the record of the management information file 204 corresponding to the target user file 201, the fact that the partial status of the acquired portion of the data became “Cache”, and the file status became a Cache status (S1304).

Next, the file virtualization program 212A reflects, in the record of the corresponding metadata DB 203 and the record of the corresponding management information file 204, the fact that the file status became a Cache status regarding the user file 201 of the other sites 110 having the same UUID and version as the target user file 201 (S1305).

Next, the file virtualization program 212A confirms whether the elapsed time from the final reference date and time has exceeded a given value regarding the Original status user file 201 of the other sites 110 having the same UUID and version as the target user file 201 (S1306). The file virtualization program 212A proceeds to the processing of S1307 when the elapsed time from the final reference date and time has exceeded a given value, and proceeds to the processing of S1308 when the elapsed time from the final reference date and time has not exceeded a given value.

In S1307, the file virtualization program 212A changes the target user file 201 that became a Cache status to an Original status, and changes the Original status user file 201 having the same UUID and version as the target user file 201 to a Cache status. In order to reflect this change, the record of the corresponding metadata DB 203 and the record of the corresponding management information file 204 are updated regarding the user file 201 having the same UUID and version as the target user file 201 in all sites 110. After completing the foregoing process, the file virtualization program 212A proceeds to the processing of S1308.

In S1308, the file virtualization program 212A adds, to the operation log 205, the recall operation from the other sites 110 performed in S1303 to the target user file 201, and then ends the processing (S1309).

### <File Reference Processing>

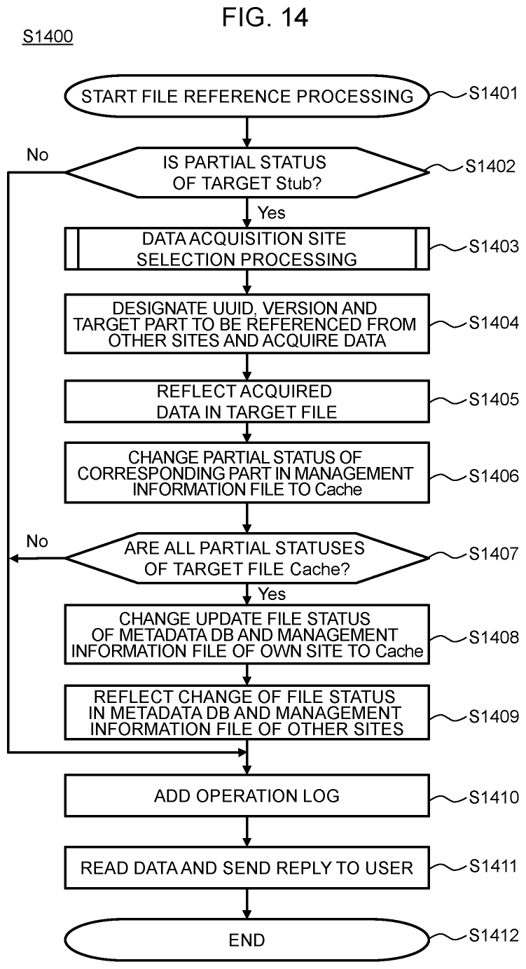

FIG. 14 is a flowchart for explaining an example of the file reference processing S1400.

The file reference processing S1400 is started when, in a read operation to a specific user file 201 from the client terminal 111, there is an access right for accessing the data of that user file 201 (S1401).

Foremost, the file virtualization program 212A refers to the management information file 204 corresponding to the target user file 201, and confirms whether the partial status of the reference target is “Stub” (S1402). The file virtualization program 212A proceeds to the processing of S1403 when the partial status is “Stub”, and proceeds to the processing of S1410 when the partial status is not “Stub”.

In S1403, the file virtualization program 212A performs the data acquisition site selection processing S1500, and decides the site 110 of the acquisition source of the data of the target user file 201.

Next, the file virtualization program 212A designates the UUID, the version, and the reference target (offset and size) of the target user file 201 from the site 110 decided in S1403, and acquires the data (S1404).

Next, the file virtualization program 212A writes the data acquired in S1404 in the target user file 201 (S1405).

Next, the file virtualization program 212A changes the partial status of the management information file 204 corresponding to the target user file 201 to “Cache” regarding the part that the data was written in S1405 (S1406).

Next, the file virtualization program 212A confirms the management information file 204 corresponding to the target user file 201, and confirms whether all partial statuses are “Cache” (S1407). The file virtualization program 212A proceeds to the processing of S1408 when all partial statuses are “Cache”, and proceeds to the processing of S1410 when there is a partial status which is not “Cache”.

In S1408, the file virtualization program 212A reflects, in the record of the metadata DB 203 and the record of the management information file 204 corresponding to the target user file 201, the fact that the target user file 201 has acquired all data and its file status has become a Cache status.

Next, the file virtualization program 212A reflects, in the record of the corresponding metadata DB 203 and the record of the corresponding management information file 204, the fact that the file status has become a Cache status regarding the user file 201 of the other sites 110 having the same UUID and version as the target user file 201 (S1409), and then proceeds to the processing of S1410.

In S1410, the file virtualization program 212A adds, to the operation log 205, the read operation to the target user file 201, and, when executed, the recall operation from the other sites 110 performed in S1404 and S1405.

Next, the file virtualization program 212A reads the reference target of the target user file 201 and replies to the user (S1411), and then ends the processing (S1412).

### <Data Acquisition Site Selection Processing>

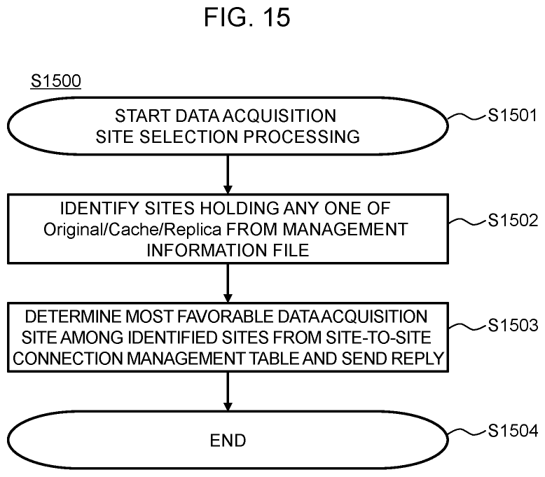

FIG. 15 is a flowchart for explaining an example of the data acquisition site selection processing S1500.

The data acquisition site selection processing S1500 is started before the acquisition of data from the other sites 110 regarding the Stub status user file 201 during the background data acquisition processing S1300, the file reference processing S1400, or the file update processing S1600 described later (S1501).

Foremost, the file virtualization program 212A identifies, from the management information file 204 corresponding to the target user file 201, the sites 110 holding a user file 201 having the same UUID and version and having a file status of one among an Original status, a Cache status, and a Replica status (S1502).

Next, the file virtualization program 212A refers to the site-to-site connection management table 207, selects the most preferable site 110 for acquiring data among the sites identified in S1502 and sends a reply regarding the selected site 110 (S1503), and then ends the processing (S1504). In this embodiment, the file virtualization program 212A selects the site 110 in which the value of the bandwidth stored in the site-to-site connection management table 207 is greatest. Note that, in addition to the communication bandwidth, the site 110 may also be selected based on the communication latency, cost of using the communication path, or other factors.

### <File Update Processing>

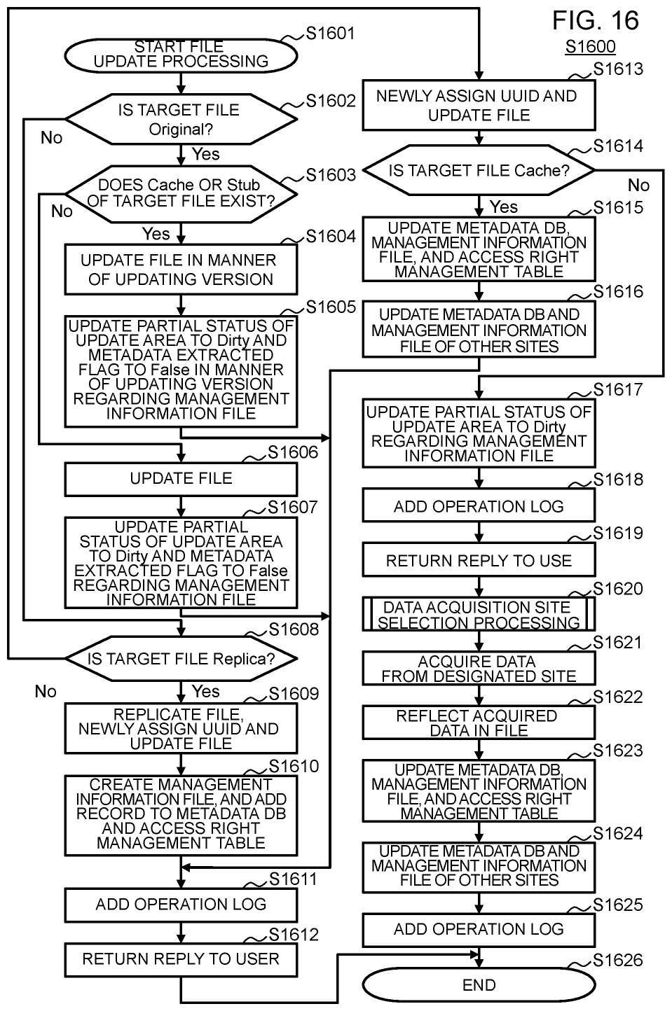

FIG. 16 is a flowchart for explaining an example of the file update processing S1600.

The file update processing S1600 is started when, in a write operation to a specific user file 201 from the client terminal 111, there is an access right for accessing the data of that user file 201 (S1601).

Foremost, the file virtualization program 212A confirms whether the file status is an Original status from the management information file 204 corresponding to the target user file 201 (S1602). The file virtualization program 212A proceeds to the processing of S1603 when the file status is an Original status, and proceeds to the processing of S1608 when the file status is not an Original status.

In S1603, the file virtualization program 212A confirms whether the target user file 201 is being referenced by another site 110 from the management information file 204 corresponding to the target user file 201. The file virtualization program 212A determines that the target user file 201 is being referenced by another site 110 when one of the sites 110 is set as a Stub holding site or a Cache holding site of the management information file 204. The file virtualization program 212A proceeds to the processing of S1604 when the target user file 201 is being referenced by another site 110, and proceeds to the processing of S1606 when the target user file 201 is not being referenced by another site 110.

In S1604, the file virtualization program 212A updates the data in a manner of updating the version of the target user file 201 based on the contents of the write operation from the client terminal 111. It is thereby possible to set aside, as an old version, the user file 201 being referenced from another site 110. Note that, when the file object storage 112 is not equipped with a version management function, for example, data of the old version may also be set aside according to a method of the file virtualization program 212A replicating the user file 201 before being updated.

Next, the file virtualization program 212A updates the partial status of the write processing target (update area) to “Dirty” and updates the metadata extracted flag to “False” in a manner of updating the version of the management information file 204 corresponding to the target user file 201 (S1605). It is thereby possible to set aside the management information file 204 of the old version of the user file 201 being referenced from another site 110. Note that, when the file object storage 112 is not equipped with a version management function, for example, data of the old version may also be set aside according to a method of replicating the management information file 204 before being updated. After completing the foregoing process, the file virtualization program 212A proceeds to the processing of S1611.

In S1606, the file virtualization program 212A updates the data of the target user file 201 based on the contents of the write operation from the client terminal 111.

Next, the file virtualization program 212A updates the partial status of the write processing target to “Dirty” and updates the metadata extracted flag to “False” regarding the management information file 204 corresponding to the target user file 201 (S1607), and then proceeds to the processing of S1611.

In S1608, the file virtualization program 212A confirms whether the file status is a Replica status from the management information file 204 corresponding to the target user file 201. The file virtualization program 212A proceeds to the processing of S1609 when the file status is a Replica status, and proceeds to the processing of S1613 when the file status is not a Replica status.

In S1609, the file virtualization program 212A replicates the target user file 201, assigns a new UUID to the replicated user file 201, and updates the data based on the contents of the write operation.

Next, the file virtualization program 212A creates a management information file 204 corresponding to the replicated user file 201, creates a record corresponding to the replicated user file 201 in the metadata DB 203 and the access right management table 206 (S1610), and then proceeds to the processing of S1611.

In S1611, the file virtualization program 212A adds the contents of the write operation to the operation log 205.

Next, the file virtualization program 212A sends a reply to the client terminal 111 to the effect that the write operation to the target user file 201 is complete (S1612), and then ends the processing (S1626).

In S1613, the file virtualization program 212A assigns a new UUID to the target user file 201, and updates the data based on the contents of the write operation.

Next, the file virtualization program 212A confirms whether the file status is a Cache status from the management information file 204 corresponding to the target user file 201 (S1614). The file virtualization program 212A proceeds to the processing of S1615 when the file status is a Cache status, and proceeds to the processing of S1617 when the file status is not a Cache status.

In S1615, the file virtualization program 212A assigns a new UUID and reflects the fact that the file status has become an Original status in relation to the record of the metadata DB 203, the record of the management information file 204 and the record of the access right management table 206 corresponding to the user file 201.

Next, the file virtualization program 212A reflects the fact that a new UUID has been assigned (fact that the file status is no longer a Cache status) to the record of the corresponding metadata DB 203 and the record of the management information file 204 regarding the user file 201 of the other sites 110 having the same UUID and version as the values that were assigned to the target user file 201 before the new UUID was assigned thereto (S1616), and then proceeds to the processing of S1611.

In S1617, the file virtualization program 212A updates the partial status of the write processing target to “Dirty” regarding the management information file 204 corresponding to the target user file 201.

Next, the file virtualization program 212A adds the contents of the write operation to the operation log 205 (S1618).

Next, the file virtualization program 212A sends a reply to the client terminal 111 to the effect that the write operation to the target user file 201 is complete (S1619).

Next, the file virtualization program 212A performs the data acquisition site selection processing S1500 (S1620), and decides the site 110 of the acquisition source of the data of the target user file 201.

Next, the file virtualization program 212A designates the UUID and the version that were assigned to the target user file 201 before the new UUID was assigned thereto from the site 110 decided in S1620, and acquires the data (data of the Stub part) of the target user file 201 (S1621).

Next, the file virtualization program 212A writes the data acquired in S1621 in the target user file 201 (S1622).

Next, the file virtualization program 212A assigns a new UUID and reflects the fact that the file status became an Original status in relation to the record of the metadata DB 203, the record of the management information file 204 and the record of the access right management table 206 corresponding to the target user file 201 (S1623).

Next, the file virtualization program 212A reflects the fact that a new UUID has been assigned (fact that the file status is no longer a Stub status) to the record of the corresponding metadata DB 203 and the record of the management information file 204 regarding the user file 201 of the other sites 110 having the same UUID and version as the values that were assigned to the target user file 201 before the new UUID was assigned thereto (S1624).

Next, the file virtualization program 212A adds, to the operation log 205, the contents of the recall operation from the other sites 110 (S1625), and then ends the processing (S1626).

### <Operation Log Analysis Processing>

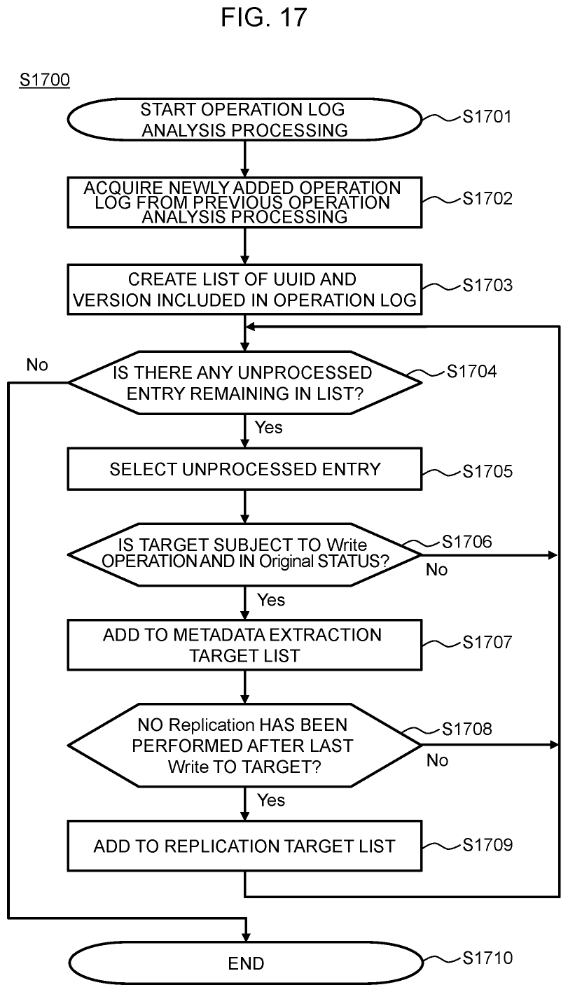

FIG. 17 is a flowchart for explaining an example of the operation log analysis processing S1700.

The operation log analysis processing S1700 is started when a given period of time has elapsed from the previous operation log analysis processing S1700 and a certain number of unprocessed operation logs has been accumulated (S1701).

Foremost, the file virtualization program 212A acquires unanalyzed operation logs 205 added after the previous operation log analysis processing S1700 (S1702).

Next, the file virtualization program 212A extracts the user file 201 as the operation target among the operation logs 205 acquired in S1702 (S1703). The file virtualization program 212A uses a combination of the UUID and the version as the identifier of the operation target, and creates a list of this value.

In S1704, the file virtualization program 212A confirms whether there is an unprocessed entry in the list created in S1703. The file virtualization program 212A proceeds to the processing of S1705 when there is an unprocessed entry, and ends the processing when there is no unprocessed entry (S1710).

In S1705, the file virtualization program 212A selects one unprocessed entry from the list created in S1703, and sets that unprocessed entry as the processing target.

Next, the file virtualization program 212A confirms, with regard to the target user file 201, whether the write operation is being performed in the operation log 205 acquired in S1702 and whether the file status is an Original status from the corresponding management information file 204 (S1706). The file virtualization program 212A proceeds to the processing of S1707 when the write operation is being performed and the file status is an Original status, and otherwise proceeds to the processing of S1704.

In S1707, the file virtualization program 212A adds the UUID and the version of the target user file 201 to the metadata extraction target list, and then proceeds to the processing of S1708.

In S1708, the file virtualization program 212A confirms whether a replication operation has been performed to the target user file 201 after the last write operation performed to the target user file 201 from the operation log 205 acquired in S1702. The file virtualization program 212A proceeds to the processing of S1709 when a replication operation has not been performed, and otherwise proceeds to the processing of S1704.

In S1709, the file virtualization program 212A adds the UUID and the version of the target user file 201 to the replication target list, and then proceeds to the processing of S1704.

### <Metadata Extraction Processing>

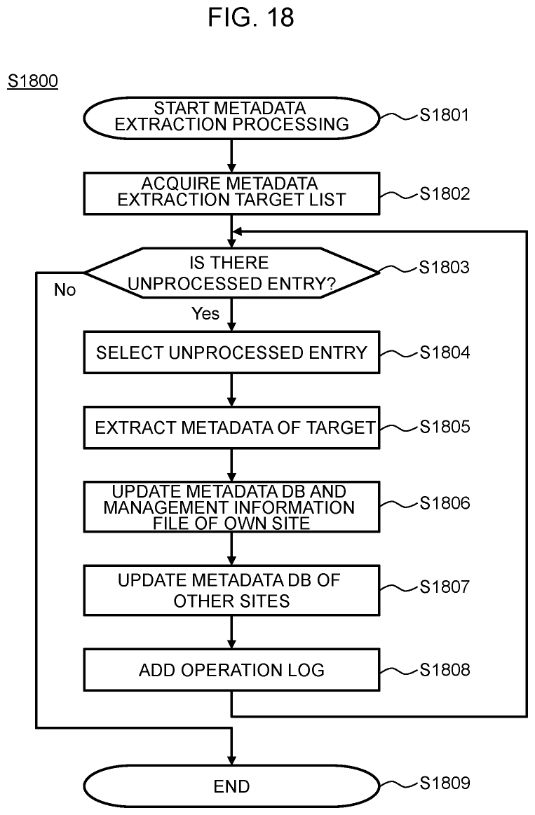

FIG. 18 is a flowchart for explaining an example of the metadata extraction processing S1800.

The metadata extraction processing S1800 is started when a given period of time has elapsed from the previous metadata extraction processing S1800 and a certain number of entries of the metadata extraction target list has been accumulated (S1801).

Foremost, the metadata extraction program 212E acquires a metadata extraction target list (S1802).

In S1803, the metadata extraction program 212E confirms whether there is an unprocessed entry in the metadata extraction target list acquired in S1802. The metadata extraction program 212E proceeds to the processing of S1804 when there is an unprocessed entry, and ends the processing when there is no unprocessed entry (S1809).

In S1804, the metadata extraction program 212E selects on unprocessed entry from the metadata extraction target list acquired in S1802, and sets that unprocessed entry as the processing target.

Next, the metadata extraction program 212E extracts the metadata of the user file 201 by accessing that user file 201 designated by the UUID and the version of the entries of the processing target or by analyzing the operation log 205 (S1805).

Next, the metadata extraction program 212E updates the metadata extracted flag of the management information file 204 corresponding to the target user file 201 to “True”, and registers the extracted metadata in relation to the record of the metadata DB 203 (S1806).

Next, the metadata extraction program 212E registers the extracted metadata in the record of the corresponding metadata DB 203 regarding the user file 201 of the other sites 110 having the same UUID and version as the target user file 201 (S1807).

Next, the metadata extraction program 212E adds, to the operation log 205, the contents of the performance of metadata extraction to the target user file 201 (S1808), and then proceeds to the processing of S1803.

### <Replication Processing>

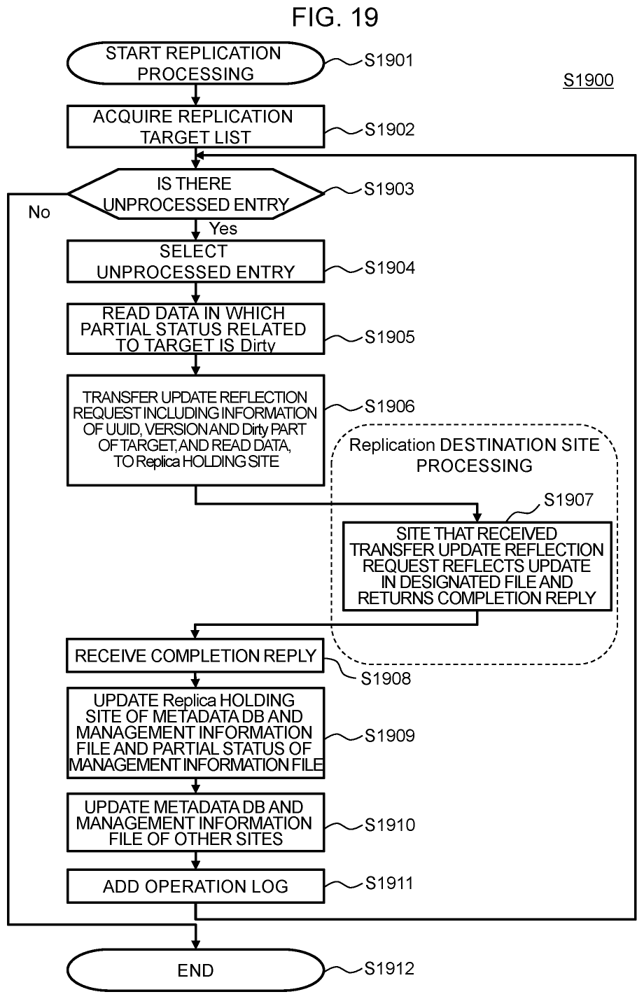

FIG. 19 is a flowchart for explaining an example of the replication processing S1900.

The replication processing S1900 is started when a given period of time has elapsed from the previous replication processing S1900, and a certain number of entries of the replication target list has been accumulated (S1901).

Foremost, the file virtualization program 212A acquires a replication target list (S1902).

In S1903, the file virtualization program 212A confirms whether there is an unprocessed entry in the replication target list acquired in S1902. The file virtualization program 212A proceeds to the processing of S1904 when there is an unprocessed entry, and ends the processing when there is no unprocessed entry (S1912).

In S1904, the file virtualization program 212A selects one unprocessed entry from the replication target list acquired in S1902, and sets that unprocessed entry as the processing target.

Next, the file virtualization program 212A identifies the part in which the partial status is “Dirty” from the corresponding management information file 204 and reads the data regarding the user file 201 designated by the UUID and the version of the entries of the processing target (S1905).

Next, the file virtualization program 212A, with regard to the target user file 201, identifies a Replica holding site from the corresponding management information file 204, and transfers an update reflection request including information of the UUID, the version, and the Dirty part (offset and size in which the partial status is “Dirty”) of the target user file 201, and the data of the Dirty part read in S1905 (S1906). For instance, in the example of FIG. 4, when there is a Dirty part in the user file 201 having a UUID of “AAAA” and a version of “2”, the file virtualization program 212A refers to the entries of the UUID “AAAA” and the version “1” and identifies “site 3” as the Replica holding site.

Next, in the other sites 110 that received the update reflection request transferred in S1906, the file virtualization program 212A writes the received data in the designated Dirty part and sends a completion reply, in response to the update reflection request, to the user file 201 of the designated UUID and version (S1907).

Next, the file virtualization program 212A receives the completion reply sent in S1907 (S1908).

Next, the file virtualization program 212A updates the partial status of the Dirty part of the management information file 204 corresponding to the target user file 201 to “Cache”, and adds, to the Replica holding site, the site 110 which succeeded in the update reflection in relation to the corresponding record of the metadata DB 203 and the corresponding record of the management information file 204 (S1909).

Next, the file virtualization program 212A updates the fact that the site 110 has been added in the record of the corresponding metadata DB 203 and the record of the corresponding management information file 204 regarding the user file 201 of the other sites 110 having the same UUID and version as the target user file 201 (S1910).

Next, the file virtualization program 212A adds, to the operation log 205, the contents of the processing of replication performed to the target user file 201 (S1911), and then proceeds to the processing of S1903.

### <Stubbing Processing>

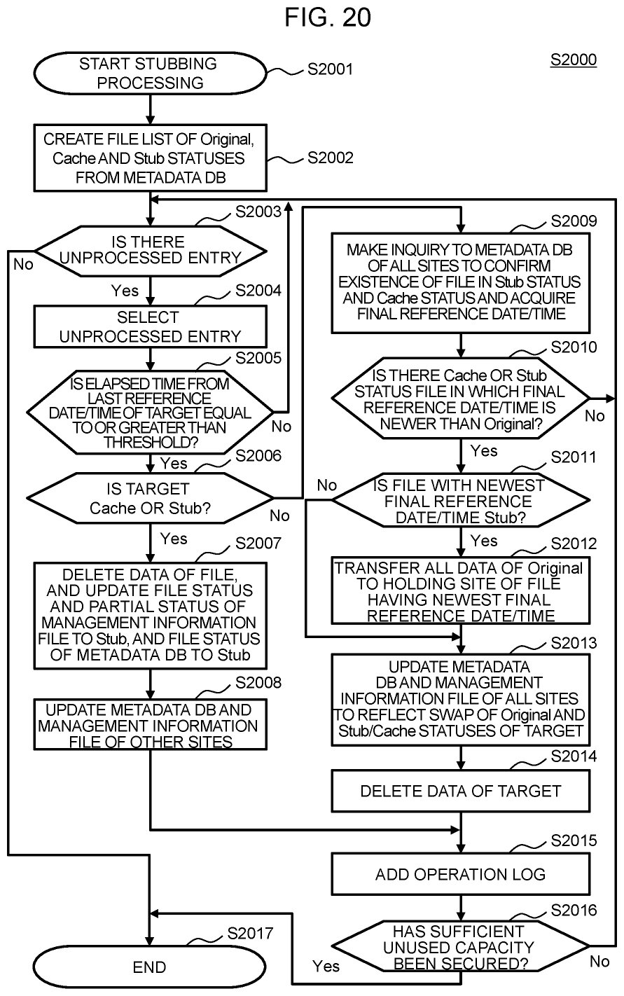

FIG. 20 is a flowchart for explaining an example of the stubbing processing S2000.

The stubbing processing S2000 is started when the ratio of the unused capacity of the file object storage 112 of the site 110 falls below a certain value (S2001).

Foremost, the file virtualization program 212A extracts the user files 201 in which the file status 404 is any one among an Original status, a Stub status, and a Cache status from the metadata DB 203, and creates a stubbing candidate file list (S2002).

In S2003, the file virtualization program 212A confirms whether there is an unprocessed entry in the stubbing candidate file list created in S2002. The file virtualization program 212A proceeds to the processing of S2004 when there is an unprocessed entry, and ends the processing when there is no unprocessed entry (S2017).

In S2004, the file virtualization program 212A selects one unprocessed entry from the stubbing candidate file list created in S2002, and sets that unprocessed entry as the processing target.

In S2005, the file virtualization program 212A confirms whether the elapsed time from the final reference date and time of the target user file 201 has exceeded a certain value (threshold). The file virtualization program 212A proceeds to the processing of S2006 when the elapsed time from the final reference date and time exceeds a certain value, and proceeds to the processing of S2003 when the elapsed time from the final reference date and time does not exceed a certain value.

In S2006, the file virtualization program 212A confirms whether the file status is a Cache status or a Stub status from the management information file 204 corresponding to the target user file 201. The file virtualization program 212A proceeds to the processing of S2007 when the file status is a Cache status or a Stub status, and proceeds to the processing of S2009 when the file status is not a Cache status or a Stub status.

In S2007, the file virtualization program 212A deletes data from the target user file 201, reflects the fact that all partial statuses have become “Stub” and that the file status has become a Stub status in the record of the management information file 204 corresponding to the target user file 201, and reflects the fact that the file status has become a Stub status in the record of the metadata DB 203 corresponding to the target user file 201.

Next, the file virtualization program 212A reflects the fact that the file status has become a Stub status in the record of the corresponding metadata DB 203 and the record of the corresponding management information file 204 regarding the user file 201 of the other sites 110 having the same UUID and version as the target user file 201 (S2008), and then proceeds to the processing of S2015.

In S2009, the file virtualization program 212A makes an inquiry to the metadata search program 212D of all sites 110, finds the user files 201 of other sites 110 having the same UUID and version as the target user file 201 and having a file status of a Stub status or a Cache status from the metadata DB 203, and acquires the final reference date and time of the found user files 201.

Next, the file virtualization program 212A confirms whether there is a user file 201 among the user files 201 having a file status of a Stub status or a Cache status found in S2009 in which the final reference date and time is newer than the target user file 201 having a file status of an Original status (S2010). The file virtualization program 212A proceeds to the processing of S2011 when there is a user file 201 of a Stub status of a Cache status in which the final update date and time is newer than the target user file 201, and proceeds to the processing of S2003 when there is no user file 201 of a Stub status of a Cache status in which the final update date and time is newer than the target user file 201.

In S2011, the file virtualization program 212A confirms whether the file status of the user file 201 having the newest final reference date and time among the user files 201 having a file status of a Stub status or a Cache status found in S2009 is a Stub status. The file virtualization program 212A proceeds to the processing of S2012 when the file status is a Stub status, and proceeds to the processing of S2013 when the file status is not a Stub status.

In S2012, the file virtualization program 212A transfers all data of the target user file 201 in which the file status is an Original status to the site 110 holding the Stub status user file 201 having the newest final reference date and time among the user files 201 having a file status of a Stub status or a Cache status found in S2009, writes the data therein, and then proceeds to the processing of S2013.

In S2013, the file virtualization program 212A changes the target user file 201 to a Stub status, and changes the user file 201 having the newest final reference date and time among the user files 201 having a file status of a Stub status or a Cache status found in S2009 to an Original status. In order to reflect the foregoing change, the file virtualization program 212A updates the corresponding record of the metadata DB 203 and the corresponding record of the management information file 204 regarding the user file 201 having the same UUID and version as the target user file 201 in all sites 110, and then proceeds to the S2014.

In S2014, the file virtualization program 212A deletes data of the target user file 201.

Next, the file virtualization program 212A adds, to the operation log 205, the contents of processing of the stubbing performed to the target user file 201 (S2015).

Next, the file virtualization program 212A confirms whether a sufficient unused area has been allocated in the stubbing processing S2000 (S2016). The file virtualization program 212A ends the processing when a sufficient unused area has been allocated (S2017), and proceeds to the processing of S2003 when a sufficient unused area has not been allocated.

Note that, when the file virtualization program 212A ends the processing before obtaining a sufficient unused capacity since there is no longer any unprocessed entry from the stubbing candidate file list in S2003, in order to obtain the target unused capacity, file virtualization program 212A may also once again perform the stubbing processing S2000 by easing the threshold (condition) of the elapsed time from the final reference date and time to a shorter period upon performing the stubbing.

According to this embodiment having the foregoing configuration, the file object storage 112 of each site 110 can create a Stub status user file 201 by narrowing down the Original status user files 201 requiring the transfer of data without having to create a Stub status user file 201 for all Original status user files 201 of the file object storage 112 of other sites 110.

Thus, according to this embodiment, since the stub information of all user files 201 is mutually held between the sites 110, the storage capacity of the storage can be reduced. Moreover, when a site 110 is added, the creation of stub information in the new site 110 is no longer required, and the launch time of the new site 110 can be reduced. Moreover, a global lock upon updating the metadata is no longer required, and the reply performance to the client terminal 111 can be improved.

Note that the foregoing embodiments were explained in detail for explaining the present invention in an easy-to-understand manner, and the present invention does not need to necessarily comprise all of the configurations explained in the embodiments. Moreover, another configuration may be added to, deleted from or replaced with a part of the configuration of each embodiment.

### (II) Supplementary Notes

The foregoing embodiment includes, for example, the following subject matter.

While the foregoing embodiment explained a case of applying the present invention to a storage system, the present invention is not limited thereto, and may be broadly applied to various other systems, devices, methods, and programs.

Moreover, while the foregoing embodiment explained a case of selecting the intended user file 201 from the site-to-site transverse metadata search result reply 900, the present invention is not limited thereto. For example, the intended user file 201 may also be selected by referring to the user file 201 and the user directory 202 of the other sites 110.

Moreover, in the foregoing embodiment, the configuration of the respective tables is merely an example, and one table may be divided into two or more tables, or all or a part of two or more tables may be one table.

Moreover, in the foregoing embodiment, while expressions such as “XX table” and “XX file” were used to explain the various types of data for the sake of convenience in explaining the present invention, there is no particular limitation to the data structure, and an expression such as “XX information” may also be used.

The foregoing embodiment comprises, for example, the following characteristic configurations.

(1) A storage system (for example, storage system 100) capable of sharing files (for example, user files 201) between a plurality of sites (for example, sites 110) each comprising a storage (for example, file object storage 112) which provides a file system, wherein: the storage comprises a storage apparatus (for example, storage apparatus 220) storing data of a file and a controller (for example, controller 210) connected to the storage apparatus; the storage system includes an associated file (for example, file other than the original file or stub file (stub information); to put it differently, file that cannot exist without the original file) which is associated with the file (for example, user file 201 (original file) of an Original status) and refers to the file; when the file is to be updated, the controller updates the file and the associated file (for example, refer to FIG. 16) based on a reference status from the associated file; and when an access request (for example, read request, operation of selecting a file of another site) for accessing a file stored in another site is received, the controller makes an inquiry to the other site, and creates an associated file for accessing the file corresponding to the access request in a site of a controller that received the access request (for example, S1202).

With the foregoing configuration, since an associated file is created according to the access request for accessing the file stored in another site, the storage does not need to store the associated files of all files in the other sites, and the number of associated files required for sharing files between sites can be reduced. For example, the storage capacity required for storing the associated files in the respective sites, and the time required for acquiring the associated files upon adding a new site, can be improved.

(2) When the access request is a search request, a controller of a storage of a first site that received the search request sends a search query (for example, search query of a site-to-site transverse metadata search) to a storage of the plurality of sites (for example, S1002), a controller of the storage that received the search query sends, to the storage of the first site, metadata of a file corresponding to the search query (for example, S1103), and the controller of the storage of the first site creates an associated file for referring to the file based on metadata of the file corresponding to the search query sent from the plurality of sites.

For example, the metadata may be sent to the request source (for example, client terminal 111), and the associated file corresponding to the metadata confirmed by the request source may be created, or the associated file of all metadata that came up in the search may be created by the request source without any confirmation to the request source.

With the foregoing configuration, for example, files can be shared based on a search query without any confirmation by the request source.

(3) The controller of the storage of the first site sends, to a request source of the search request, metadata of the file corresponding to the search query sent from the plurality of sites (for example, S1005), and when a request for accessing the file corresponding to the search query is received from the request source of the search request (for example, S1201), the controller creates an associated file for referring to the file.

With the foregoing configuration, since the search query is executed in all sites, for example, the user can comprehend the sites storing the intended file, and the file can be appropriately shared.

(4) The storage apparatus of the storage of each of the plurality of sites comprises a metadata DB (for example, metadata DB 203) which stores metadata of files and associated files stored in its own site, and the controller of the storage that received the search query acquires metadata of the file corresponding to the search query from the metadata DB and sends the acquired metadata to the storage of the first site (for example, refer to FIG. 11).

With the foregoing configuration, since a metadata DB is provided in each site, for example, the storage can easily and promptly acquire the metadate of the file corresponding to the search query.

(5) The storage apparatus of the storage of each of the plurality of sites stores access right management information (for example, access right management table 206) for managing a metadata access right for accessing the metadata stored in the metadata DB, and a data access right for accessing the data of the file stored in the storage apparatus (for example, refer to FIG. 7), the controller of the storage that received the search query acquires metadata of the file corresponding to the search query from the metadata DB and, among the acquired metadata, sends, to the storage of the first site, the metadata for which a metadata access right is determined to exist based on the access right management information (for example, refer to FIG. 11), and when it is determined that there is a data access right for accessing the data of the file based on the access right management information, the controller of the storage instructed to access the data of the file (for example, read operation, write operation or the like is requested) acquires the data of the file from its own site or another site and sends the acquired data to a request source of the access (for example, refer to FIG. 14 and FIG. 16).

According to the foregoing configuration, for example, control such as “refrain from showing the search result (metadata) to predetermined users”, and “allow predetermined users to conduct a search for confirming the existence of a certain type of file, but prohibit such predetermined users from accessing data (real data) of that file” can be realized. Note that such predetermined users can access the metadata and file data by taking steps such as paying a fee or being granted an access right from the administrator.

(6) When the file is updated, the associated file for referring to the file is also updated (for example, S1605, S1607).

According to the foregoing configuration, for example, since the associated file is also updated when the original file is updated, consistency between the original file and the associated file can be maintained.

When a request or updating the data of a file in another site is received from the client terminal, the controller of the storage may also create a file corresponding to the file of the other site, and update the data based on the created file (for example, S1604). For example, when someone is referring to a file (original file) of another site, if the original file is updated without permission, it will be inconvenient for that person. With respect to this point, according to the foregoing configuration, consistency of data with the other sites can be maintained by creating a file (file of a different version, replicated file, etc.) corresponding to the original file without destroying the original file.

(7) When the file is being referred to from the associated file, the file is updated while setting aside the file before being updated (for example, S1604), and the associated file can also be updated by acquiring the data of the file by selecting the file before being updated and the file after being updated (for example, S1411).

With the foregoing configuration, when data of a file (original file) is updated, for example, a file of a different version is created and data is updated based on the created file. For example, according to the foregoing configuration, when data of a file of another site is to be acquired, since the version of that file will be designated, it is possible to avoid a situation where inconsistent data, which is midway during its update process, is acquired.

(8) When a frequency (for example, final reference date and time) of referring to the file is less (for example, newer) than a frequency (for example, final reference date and time) that the associated file of another site is referenced, the file and the associated file are switched (for example, refer to FIG. 20).

With the foregoing configuration, since the positioning (original file) of the file of its own site and the file of the other sites is switched, for example, according to the reference frequency of the file, there is no need to redundantly hold data, and the data volume of the overall system can be reduced.

(9) The associated file is created as a stub file (for example, user file 201 of a Stub status) that does not contain data, and data is acquired from the file asynchronous to the access request (for example, refer to FIG. 12 and FIG. 13).

If data is acquired from another site each time a file of that other site is accessed, much time is required for reading such data. With the foregoing configuration, for example, since data will exist in its own site by acquiring in advance such data of the file of the other sites based on the stub file, the data can be promptly provided to the request source of the access request.

(10) The file is associated with a UUID (Universally Unique Identifier) and a version (for example, refer to FIG. 2), and the controller of the storage creates an associated file by associating the UUID and the version, and creates information indicating a file path of the associated file in its own site (for example, refer to FIG. 5).

With the technology described in PTL 1 described above, since a global lock between the sites is acquired and reflected in a plurality of sites mutually holding the associated file during the operation of a directory, the reply performance in response to the operation in the client terminal will deteriorate. With respect to this point, with the foregoing configuration, since the file is identified based on the UUID and the version (real path), different virtual paths of the file can be used between the sites. Since the same file can be accessed so as long as the real path is consistent as described above, even if the file name (virtual path) is renamed in its own site, there is no need to reflect such file name in the other sites, and there is no need to acquire a global lock. It is thereby possible to improve the reply performance during the operation of a directory in the file system.

(11) The storage apparatus of the storage of each the plurality of sites stores site-to-site connection management information (for example, site-to-site connection management table 207) for managing a connection status between the sites (for example, refer to FIG. 8), the storage apparatus of the storage of each the plurality of sites includes data site information (for example, Cache holding site 407, Replica holding site 408) indicating the sites containing all data of the file, and the controller of the storage decides the site from which the data of the file is to be acquired based on the data site information and the site-to-site connection management information (for example, refer to FIG. 15), and acquires the data from the decided site.

With the foregoing configuration, since the site of the acquisition destination of data of the file is decided based on the site-to-site connection management information, for example, data can be optimally acquired by prescribing in advance the bandwidth between sites, latency, billing information and other information in the site-to-site connection management information.

Items included in a list according to a format of “at least one among A, B, and C” should be understood to mean (A), (B), (C), (A and B), (A and C), (B and C) or (A, B, and C). Similarly, items included in a list according to a format of “at least one among A, B, or C” should be understood to mean (A), (B), (C), (A and B), (A and C), (B and C) or (A, B, and C).

### REFERENCE SIGNS LIST

100 . . . storage system, 110 . . . site, 111 . . . client terminal, 112 . . . file object storage (storage).

1. A storage system, comprising:
a plurality of sites, each comprising a plurality of storages which provide a file system,
wherein each storage comprises a storage apparatus storing data of a file and a controller connected to the storage apparatus,
wherein the plurality of storages respectively include, at each site, the file which includes data, an associated file which is associated with the file and refers to the file, and a metadata database which stores metadata regarding the file and the associated file,
wherein the plurality of storages respectively include, at each site, a different file, a different associated file, and a different metadata database,
wherein the controller manages the file and the associated file in a same site, and, when the file is to be updated in the same site, the controller updates the file and the associated file based on a reference status from the associated file, and updates the metadata database of the site,
wherein when an access request for accessing a file stored in another site is received, the controller makes an inquiry to a plurality of other sites, the metadata databases of the plurality of other sites being in a non-updated state with respect to reflecting the update of the file and the associated file,
wherein a controller of a site receives the inquiry and upon receiving the inquiry, updates the metadata database to reflect the update of the file and the associated file and returns a reply to a controller of the site of an inquiry source based on the metadata database in which the update of the file and the associated file have been reflected, and
accessing the file corresponding to the access request in a site of a controller that received the access request based on the reply to the inquiry and based on the metadata in which the update of the file and the associated file have been updated, and accesses the data of the file based on the created associated file.

2. The storage system according to claim 1,
wherein when the access request is a search request, a controller of a storage of a first site that received the search request sends a search query to storages of the plurality of other sites,
wherein a controller of the storage that received the search query sends, to the storage of the first site, metadata of a file corresponding to the search query, and
wherein the controller of the storage of the first site creates an associated file for referring to the file based on metadata of the file corresponding to the search query sent from at least one of the plurality of sites.

3. The storage system according to claim 2,
wherein the controller of the storage of the first site sends, to a request source of the search request, metadata of the file corresponding to the search query sent from the at least one of the plurality of sites, and
wherein when a request for accessing the file corresponding to the search query is received from the request source of the search request, the controller creates an associated file for referring to the file.

4. The storage system according to claim 2,
wherein the controller of the storage that received the search query acquires metadata of the file corresponding to the search query from the metadata database and sends the acquired metadata to the storage of the first site.

5. The storage system according to claim 4,
wherein the storage apparatus of the storage of each of the plurality of sites stores access right management information for managing a metadata access right for accessing the metadata stored in the metadata database, and a data access right for accessing the data of the file stored in the storage apparatus,
wherein the controller of the storage that received the search query acquires metadata of the file corresponding to the search query from the metadata DB and, among the acquired metadata, sends, to the storage of the first site, the metadata for which a metadata access right is determined to exist based on the access right management information, and
wherein when it is determined that there is a data access right for accessing the data of the file based on the access right management information, the controller of the storage instructed to access the data of the file acquires the data of the file from its own site or another site and sends the acquired data to a request source of the access.

6. The storage system according to claim 1,
wherein, when the file is updated, the associated file for referring to the file is also updated.

7. The storage system according to claim 6,
wherein when the file is being referred to from the associated file, the file is updated while setting aside the file before being updated, and
wherein the associated file can also be updated by acquiring the data of the file by selecting the file before being updated and the file after being updated.

8. The storage system according to claim 6,
wherein, when a frequency of referring to the file is less than a frequency that the associated file of another site is referenced, the file and the associated file are switched.

9. The storage system according to claim 1,
wherein the associated file is created as a stub file that does not contain data, and data is acquired from the file asynchronously to the access request.

10. The storage system according to claim 1,
wherein the file is associated with a UUID (Universally Unique Identifier) and a version, and
wherein the controller of the storage creates an associated file by associating the UUID and the version, and creates information indicating a file path of the associated file in its own site.

11. The storage system according to claim 1,
wherein the storage apparatus of the storage of each the plurality of sites stores site-to-site connection management information for managing a connection status between the sites,
wherein the storage apparatus of the storage of each the plurality of sites includes data site information indicating the sites containing all data of the file, and
wherein the controller of the storage decides the site from which the data of the file is to be acquired based on the data site information and the site-to-site connection management information, and acquires the data from the decided site.

12. The storage system according to claim 1,
wherein the file has an original status, and
wherein the associated file includes a file of a stub status, a file of a cache status, and a file of a replica status.

13. A data management method in a storage system capable of sharing files between a plurality of sites each comprising a storage which provides a file system, wherein each storage comprises a storage apparatus storing data of a file and a controller connected to the storage apparatus, wherein the plurality of storages respectively include, at each site, the file which includes data, an associated file which is associated with the file and refers to the, and a metadata database which stores metadata regarding the file and the associated file, and wherein the plurality of storages respectively include, at each site, a different file, a different associated file, and a different metadata database, wherein the data management method comprises the steps of:
managing, by the controller, the file and the associated file in a same site, and when the file is to be updated in the same site, the updating, by the controller, the file and the associated file based on a reference status from the associated file, and additionally updates the metadata database of the site;
when an access request for accessing a file stored in another site is received, inquiring, by the controller, to a plurality of other sites, the metadata databases of the plurality of other sites being in a non-updated state with respect to reflecting the update of the file and the associated file;
receiving, by a controller of a site that received the inquiry, and upon receiving the inquiry, updating the metadata database to reflect the update of the file and the associated file;
returning, by the controller of the site that received the inquiry, a reply to a controller of the site of an inquiry source based on the metadata database in which the update of the file and the associated file have been reflected; and
creating, by a controller of the inquiry source, an associated file for accessing the file corresponding to the access request in a site of a controller that received the access request based on the reply to the inquiry and based on the metadata in which the update of the file and the associated file have been updated, and accesses the data of the file based on the created associated file.

14. The storage system according to claim 1,
wherein when the file is to be updated in the same site, the controller updates the metadata database of the same site, and updates the metadata database of another site of an associated file of the other site referring to the file of the same site.
